(19) United States
(12) Patent Application Publication
(10) Pub. No.: US 2010/0288704 A1
(43) Pub. Date: Nov. 18, 2010

(54) Flow-Through Substrate Assemblies and Methods for Making and Using Said Assemblies

(76) Inventors: Jeffrey Michael Amsden, Hammondsport, NY (US); Thomas William Hastings, Elmira, NY (US); Marcos German Ortiz, Painted Post, NY (US); David Lambie Tennent, Campbell, NY (US); Andrea Nichole Werner, Corning, NY (US)

Correspondence Address: CORNING INCORPORATED, SP-TI-3-1, CORNING, NY, 14831, US

(21) Appl. No.: 12/464,463

(22) Filed: May 12, 2009

(51) Int. Cl. B01D 35/30; B01D 15/00; B23P 11/00

(52) U.S. Cl. 210/688; 210/483; 29/428

(57) ABSTRACT

Assemblies comprised of mounted flow-through substrates and methods for using and making said assemblies.

### FIELD OF THE DISCLOSURE

The present disclosure relates to assemblies comprised of mounted flow-through substrates, wherein the flow-through substrates may be substantially unobstructed, and methods for making and using said assemblies.

### BACKGROUND

Flow-through substrates may be used, for example, as supports for catalysts for carrying out chemical reactions or as sorbents or filters for the capture of particulate, liquid, or gaseous species from fluids such as gas streams and liquid streams. For example, certain flow-through substrates comprising activated carbon may be used as catalyst substrates or for the capture of heavy metals from gas streams.

The inventors have now developed novel methods of making assemblies comprised of flow-through substrates. In at least some embodiments, the flow-through substrates are in the form of honeycomb bodies, and/or may optionally comprise activated carbon. The presently disclosed assemblies may hold the flow-through substrates essentially in place regardless of the angle at which the assembly is deployed, and in some embodiments may ensure sealing between the flow-through substrates and a surrounding frame. In various exemplary embodiments, the assembly comprises flow-through substrates mounted in a metal frame using compression material, for example mat material, bonding material, and/or retaining members.

### SUMMARY

Various embodiments of the present disclosure relate to assemblies of flow-through substrates mounted in a frame with at least one compression material, such as a mat material and/or springs, bonding material, and/or retaining members. In at least some embodiments, the flow-through substrates are substantially unobstructed. The present disclosure further relates to methods for making and using the assemblies.

### BRIEF DESCRIPTION OF THE DRAWINGS

The accompanying drawings are included to provide a further understanding of the invention, and are incorporated in and constitute a part of this specification. The drawings are not intended to be restrictive of the invention as claimed, but rather are provided to illustrate embodiments of the invention and, together with the description, serve to explain the principles of the invention.

FIG. 1A is a schematic representation of an exemplary flow-through substrate prepared for insertion into an exemplary frame according to one embodiment of the invention.

FIG. 1B is a schematic representation of an exemplary frame according to one embodiment of the invention.

FIG. 1C is a schematic representation of an exemplary configured flow-through substrate assembly according to one embodiment of the invention.

FIG. 1D is a schematic representation of an exemplary housing holding an exemplary flow-through substrate assembly according to one embodiment of the invention.

FIG. 2A is a schematic representation of an exemplary square pushing tool used in making an exemplary flow-through substrate assembly according to one embodiment of the invention.

FIG. 2B is a schematic representation of an exemplary square funnel tool used in making an exemplary flow-through substrate assembly according to one embodiment of the invention.

### DETAILED DESCRIPTION

It is to be understood that both the foregoing general description and the following detailed description are exemplary and explanatory only, and are not restrictive of the invention, as claimed. Other embodiments of the invention will be apparent to those skilled in the art from consideration of the specification and practice of the invention disclosed herein. It is intended that the specification be considered as exemplary only, with the true scope and spirit of the invention being indicated by the claims.

The present disclosure relates to assemblies comprised of mounted flow-through substrates. In at least some embodiments, the flow-through substrates are substantially unobstructed. In various exemplary embodiments, the assemblies comprise flow-through substrates mounted in a frame using compression material, bonding material, and/or retaining members.

As used herein, the term “flow-through substrate,” and variations thereof, means a shaped body comprising inner passageways, such as straight or serpentine channels and/or porous networks or other configurations that would permit the flow of a fluid stream through the body. The flow-through substrate comprises a dimension in the flow-through direction of at least 1 cm from an inlet end to an outlet end of the body, for instance, at least 2 cm, at least 3 cm, at least 4 cm, at least 5 cm, at least 6 cm at least 7 cm, at least 8 cm, at least 9 cm, at least 10 cm, or at least 15 cm from the inlet end to the outlet end of the flow-through substrate.

In various embodiments of the present invention, the flow-through substrate may be a honeycomb substrate comprising an inlet end, an outlet end, and inner channels extending from the inlet end to the outlet end. In one embodiment, the honeycomb substrate comprises a multiplicity of cells extending from the inlet end to the outlet end, the cells being defined by intersecting cell walls. The honeycomb substrate may optionally comprise one or more selectively plugged honeycomb cell ends to provide a wall flow-through structure that allows for more intimate contact between the fluid stream and cell walls.

The flow-through substrates useful according to the present disclosure include, for example, solid materials such as ceramic and/or carbon-based bodies. Ceramic bodies include, but are not limited to, those comprised of cordierite and silicon carbide. Carbon-based materials include, but are not limited to, synthetic carbon-containing polymeric material (which may be cured or uncured); activated carbon powder; charcoal powder; coal tar pitch; petroleum pitch; wood flour; cellulose and derivatives thereof; natural organic materials, such as wheat flour, wood flour, corn flour, nut-shell flour; starch; coke; coal; or mixtures thereof. In some embodiments, the carbon-based material comprises a resin such as, but not limited to, phenolic resin, acrylic resin, or a resin based on furfuryl alcohol. In some further embodiments, the carbon-based material may comprise activated carbon, for example, activated carbon resulting from the carbonization and activation of any carbon-based material mentioned above. In at least certain embodiments, the assemblies comprise one or more flow-through substrates, some or all of which may comprise the same material, or the material of the flow-through substrates may be independently chosen from one another. The flow-through substrates may, for example, be extruded honeycomb bodies.

In various exemplary embodiments, the flow-through substrates may be shaped in any manner. In various non-limiting examples, a cross-section of the flow-through substrates perpendicular to the length of the inner passageways may be brick- or cube-shaped, i.e., have six sides or faces, which are at approximately right angles to one another. In other exemplary embodiments, the flow-through substrates have a round, diamond, or hexagon shaped cross-section. In various exemplary embodiments, the cross-section of the flow-through substrates are shaped in a manner permitting maximum flow through the bodies when assembled together, e.g., in a geometry that permits close packing.

In various exemplary embodiments of the present disclosure, the flow-through substrates may be comprised of material configured to capture at least one heavy metal from a fluid stream. As used herein, “configured to capture at least one heavy metal,” and variations thereof, is intended to mean that the material is capable of sorbing at least 0.01 mg of the heavy metal per gram of the material (referred to herein in units of mg/g). In some embodiments, the material is capable of sorbing the heavy metal in the amount of at least 0.05 mg/g, 0.1 mg/g, 0.5 mg/g, 0.8 mg/g, 1.0 mg/g, 2.0 mg/g, or 3.0 mg/g. Various embodiments of the present disclosure include the methods of using the assemblies disclosed herein to capture at least one contaminant such as a heavy metal from a fluid stream.

As used herein, the terms “sorb,” “sorption,” “sorbed,” and variations thereof mean the adsorption, sorption, or other entrapment of at least one contaminant on a flow-through substrate, either physically, chemically, or both physically and chemically. The term “contaminants,” and variations thereof, as used herein includes heavy metals. A “heavy metal” may exist in elemental form or in any oxidation state.

Non-limiting examples of heavy metals include cadmium, mercury, chromium, lead, barium, beryllium, nickel, cobalt, vanadium, antimony, silver, thallium, and arsenic. Additional contaminants include zinc, copper, manganese and selenium.

In various embodiments of the present disclosure, the flow-through substrates may be mounted in a frame body. As used in the present disclosure, “frame,” “frame body,” and variations thereof, are intended to mean a structure capable of containing or holding one or more flow-through substrates in at least one opening. In various exemplary embodiments, the frame body may be comprised of horizontal and/or vertical beams, for example such that a grid is formed. In one exemplary embodiment, the grid may comprise at least one opening, for example two or more openings, configured for receiving and holding at least one flow-through substrate. In other exemplary embodiments, the frame may be formed by individual compartments of flow-through substrates assembled together. In various exemplary embodiments, the frame may be configured such that it stacks flow-through substrates in any orientation, including in the horizontal, vertical, and/or diagonal directions.

In various exemplary embodiments, the frame comprises at least one opening, for example two or more openings. By way of example, a series of at least two openings may comprise at least two openings in a vertical direction and at least two openings in a horizontal direction, i.e. the frame body may comprise at least four openings, each configured for receiving and holding at least one flow-through substrate. As a further example, in at least one embodiment, the frame is configured such that it may contain five openings in a horizontal direction and five openings in a vertical direction, for a total of 25 openings in the grid. The appropriate number of openings in the frame may easily be determined by those skilled in the art, and may be chosen, for example, to accommodate the size of the housing opening, the size of the flow-through substrates, in view of manufacturing limitations, and/or based on the maneuverability of the assembly. One or more flow-through substrates may be trimmed or otherwise modified or sized to fit appropriately into a frame opening. Thus, in some embodiments, the flow-through substrates may be of the same size and shape, while in other embodiments one or more flow-through substrates may be different from another in shape or size. In at least one exemplary configuration, the flow-through substrate inlet and outlet flow surfaces are substantially unobstructed by the frame.

In various exemplary embodiments, a single frame opening may contain at least one flow-through substrate, for example, two or more flow-through substrates. In at least one embodiment, the frame opening may be substantially the same size as the flow-through substrates, and in another embodiment, may be greater than the size of the flow-through substrates.

In at least one embodiment, two or more flow-through substrates may be inserted into a single frame opening, for example after optionally being bonded together. The bonding material may include, but is not limited to, ceramic and/or carbon-based materials, which may be the same as or different from those materials of the flow-through substrate, and any glue or epoxy, as well as any other appropriate material. The appropriate bonding material may easily be determined by those skilled in the art, and may be chosen, for example, so that it does not affect the functionality or thermal properties of the flow-through substrate.

The frame body may be comprised of any material known to those of skill in the art. For example, the frame material according to the present disclosure may comprise at least one metal, ceramic, plastic, polymer, or wood material. In various exemplary embodiments, the frame material is comprised of at least one metal, for example stainless steel and/or aluminum.

In various embodiments, the frame may be coated or treated with one or more coating or finish. For example, in various embodiments, the frame may be coated with one or more coatings to protect the frame material from contaminants in the fluid stream, to protect against exudation of materials from the frame material, and/or to provide electrical insulation. For example, in one embodiment, a stainless steel frame may be coated with aluminum oxide or glass. The appropriate frame material and optional coatings may easily be determined by those skilled in the art based on desired properties for any particular application, such as, for example, the desired corrosion and temperature resistance, strength, expansion properties, weight, and ease of ability to machine the material. In at least one embodiment of the present disclosure, the frame is free-standing and/or dimensionally stable.

As used herein, the term “compression material,” and variations thereof, is intended to include materials that may mount and hold the flow-through substrate in the frame body using pressure applied to the outer portion of the flow-through substrate, i.e., surfaces other than the inlet and outlet surfaces of the flow-through substrate. In various embodiments, the compression material may be, but is not limited to, mat material, fiberglass insulation, and/or springs.

In various exemplary embodiments, the compression material may be pieces or strips of a material, such as a mat material, placed on the sides of the flow-through substrates that will be adjacent to the frame body, and the flow-through substrates are then mounted in the frame, e.g. in the openings. In at least one embodiment, the compression material may extend across the entire circumference of the sides of the flow-through substrate. In another embodiment, pieces of compression material may be placed on portions of the sides of the flow-through substrate and still hold the body in place. For example, pieces or strips of compression material may be placed on two opposite sides of a flow-through substrate and not the other sides. In a further embodiment, any open space between the sides of the flow-through substrate and the frame which does not have compression material may be sealed to prevent gas by-pass using any material other than compression material, such as bonding material.

The mat material described herein includes any type of fibrous material that is useful for mounting the flow-through substrates in the assembly and holding them substantially in place. By way of example, fibrous mat material may include conventional intumescent or non-intumescent mats. In various exemplary embodiments, “green” mat material, which is substantially free of binding material, may be used. Non-limiting examples of mat material include, but are not limited to, silicone fiber mats, for example alumino-silicate fiber mats, such as those sold under the trade name FIBERFRAX® by the company Unifrax.

The compression material may be selected for its properties, including, but not limited to, its compression and expansion properties, thermal properties, weight, and porosity. The material width and thickness may be selected to adequately secure the flow-through substrate based on its size and weight, the gap between the substrate and the frame, and the desired pressure to hold the flow-through substrate in place, particularly in view of the expected loads. In various exemplary embodiments, more than one type of mat material may be used as compression material, and in additional embodiments, more than one layer of mat material may be used to mount and hold the flow-through substrates. Selection of the appropriate compression material, as well as its properties, such as the width and thickness of mat material, are well within the ability of those skilled in the art to determine.

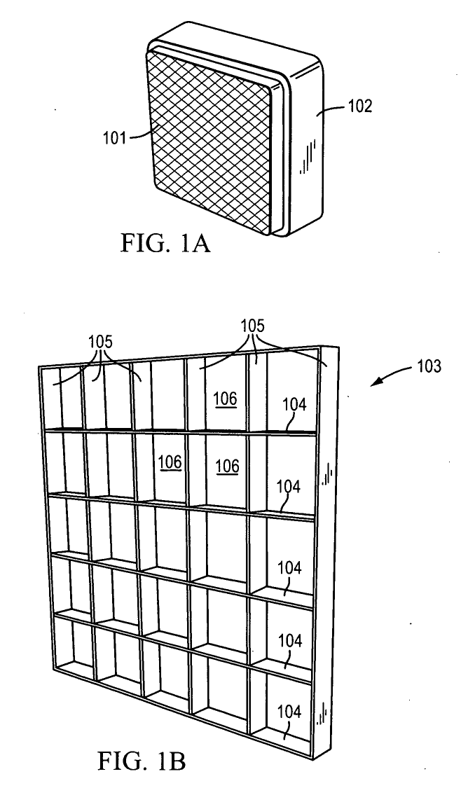

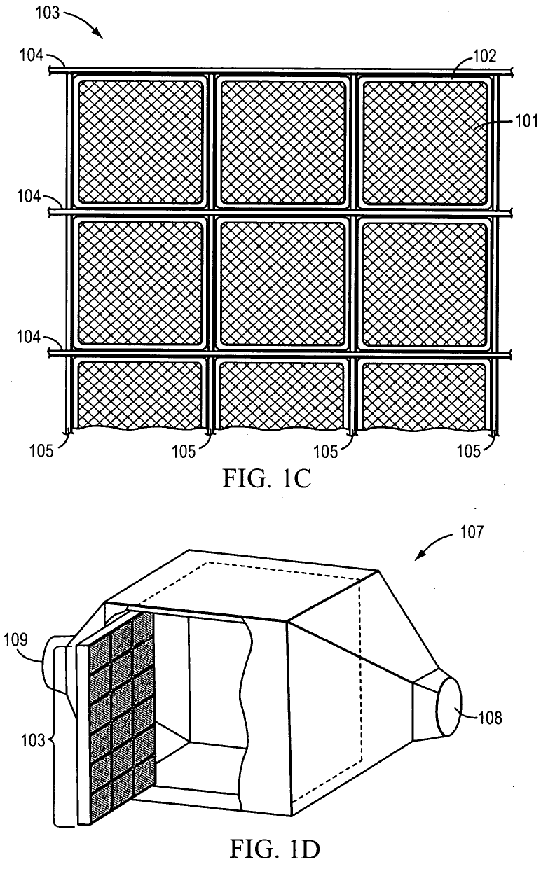

For example, as depicted in FIG. 1A, which is an example of an exemplary flow-through substrate and mat material configuration, a flow-through substrate 101 is wrapped in mat material 102. As depicted in FIG. 1B, which is an example of a frame body, the frame body 103, is comprised of a series of horizontal beams 104 and vertical beams 105, such that openings 106 are configured to receive and hold the flow-through substrates. In some embodiments, the frame body may be designed to include filleted corners at the intersection of the vertical and horizontal frame members. Such corners, illustrated for example in U.S. Pat. No. 4,335,023, may improve the strength of the assembly.

In various exemplary embodiments, the compression material may aid in protecting and holding or maintaining the flow-through substrates in place in the frame body, even if the frame is positioned horizontally, for example for vertical gas flow. Thus, in various embodiments, assemblies according to the present disclosure may eliminate the need for metal mesh, wire support, and/or other fixtures, and further may add the flexibility of deploying the system at any angle.

For example, as depicted in FIG. 1C, which is an example of an assembly, the frame body 103 holds a series of flow-through substrates 101 wrapped in mat material 102 between the horizontal beams 104 and vertical beams 105.

In various exemplary embodiments, bonding material may be used to mount and hold the flow-through substrates in the frame. The bonding material may include, but is not limited to, ceramic and/or carbon-based materials, which may be the same as or different from those materials of the flow-through substrate, and any glue or epoxy. The appropriate bonding material may easily be determined by those skilled in the art, and may be chosen, for example, so that it does not materially affect the functionality or thermal properties of the flow-through substrate.

In various exemplary embodiments, the flow-through substrates may be mounted and held in place in the frame using retaining members chosen from retaining bars, mesh or perforated screens, or diagonal bracings or stiffeners placed at the inlet end and/or outlet end of the flow-through substrates. The appropriate retaining member may easily be determined by those skilled in the art, and may be chosen, for example, so that it does not materially affect the functionality of the flow-through substrate.

In various exemplary embodiments, the flow-through substrates may be mounted and held in place in the frame using a combination of compression material, bonding material, and/or retaining members.

Assemblies of the present disclosure may be used, for example, for the sorption of contaminants from a fluid. In various exemplary embodiments, a fluid stream may be passed through inner passageways of at least one flow-through substrate in the assembly, which may act as a sorbent for at least one contaminant present in the fluid stream. The fluid stream may be in the form of a gas or a liquid. The gas or liquid may also contain another phase, such as a solid particulate in the gas or liquid stream, or droplets of liquid in a gas stream. In one embodiment, the fluid stream may be a gas stream comprising coal combustion flue gases (such as from bituminous and sub-bituminous coal types or lignite coal) or syngas streams produced in a coal gasification process.

In various embodiments of the present disclosure, the flow-through substrate assemblies may be installed in a housing as a single unit. For example, as depicted in FIG. 1D, the assembly or flow-through substrate-containing frame 103 may be inserted into a housing 107, wherein gas flows from the inlet 108, through the assembly 103, and exits the outlet 109.

In various exemplary embodiments, the flow-through substrate assembly may be secured or sealed in a housing unit using materials that include, but are not limited to, the compression materials identified above, e.g., mat material, springs, and fiberglass insulation, and/or bonding material. In at least one embodiment, these materials may further reduce or prevent gas flow from bypassing the flow-through substrates and/or frames.

In various embodiments of the present disclosure, the assemblies may be arranged one after another in series, for example within one housing unit. Each assembly may be independently or jointly secured or sealed in the housing unit using at least one of the materials identified above. For example, in at least one embodiment the assemblies may be installed in a system such that the gas flows through one assembly and then the next, etc., in series. It is well within the ability of one skilled in the art to determine the appropriate number of assemblies for a given application and the conditions for their installation, such as the distance or sealing/gasketing requirements between the assemblies and between the assemblies and the housing.

In at least one embodiment of the present disclosure, the configuration of the assembly may permit removal of one or more flow-through substrates without disturbing the remaining flow-through substrates. For example, one or more flow-through substrates may be removed due to damage or exhaustion or to test the body. In one embodiment, the flow-through substrate may be reinserted after repair and/or cleaning, and in another, it may be replaced.

The present disclosure further relates to methods of mounting flow-through substrates, and methods of making the assemblies of the present disclosure. In various embodiments, the method comprises applying compression material to the flow-through substrates and/or frame openings, and inserting the flow-through substrates into the frame openings. As used herein, the term “inserting,” “mounting,” and variations thereof, are intended to include placing the flow-through substrate in the frame by maneuvering the flow-through substrate and/or the frame and/or frame elements being formed into the frame. For example, in at least one embodiment, the flow-through substrate may be pushed into the frame, and in another embodiment, the frame or frame elements may be pressed onto the flow-through substrate. In various exemplary embodiments, the flow-through substrates may be inserted into the frame one at a time or more than one at a time. In a further embodiment, frame elements are placed around the flow-through substrate during assembly of the frame. In this embodiment, for example, compression force may be applied to the flow-through substrate, optionally with a compression material or with bonding material between the frame elements and sides of the flow-through substrate. The methods of the present disclosure may produce a snug fit for the flow-through substrate in the frame body by allowing the compression material to create pressure that holds the flow-through substrate substantially in place.

In at least one exemplary embodiment, the methods comprise inserting flow-through substrates into the frame openings using a funnel and pushing tool to securely mount the flow-through substrates with the compression material in the frame body. For example, a flow-through substrate may be mounted by wrapping a flow-through substrate in mat material and then placing the body in a funnel that is substantially shaped like the flow-through substrate and corresponding frame opening, such as a square, and channeling the body and mat material into the frame by pushing it with a pushing tool until it is completely inside the frame and no parts of the mat are left outside the frame. In various embodiments, the pushing tool may be of the same shape as the funnel and the same size as the funnel opening. In various embodiments, the pushing tool may further have a flat side to abut and push the flow-through substrate and may have a handle or other means for removing the tool from the funnel and/or frame.

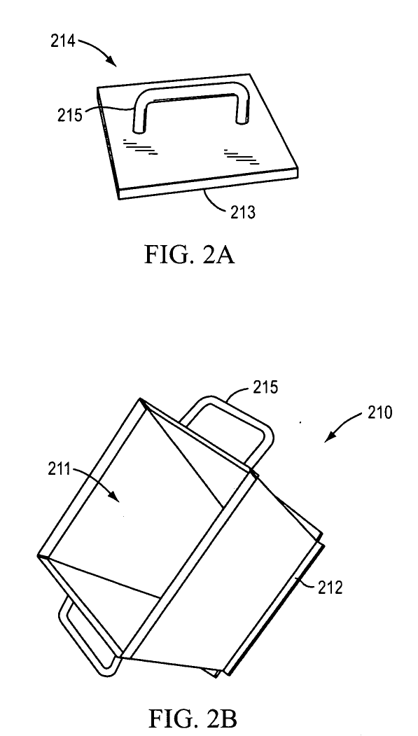

For example, as depicted in FIG. 2B, which is an example of a square funnel, the funnel 210 has an inlet 211 and an outlet 212, and the inlet 211 has a larger area than the funnel outlet 212. A square flow-through substrate is placed at the inlet 211 of the funnel and pushed through the funnel 210 using the flat side 213 of a pushing tool 214, an example of which is depicted in FIG. 2A. The pushing tool 214 and funnel 210 may be removed from the frame after insertion using handles 215.

In other exemplary embodiments, the flow-through substrate may be inserted using devices or materials other than the funnel identified above or without any additional devices or materials. For example, in one exemplary embodiment, the flow-through substrate may be covered or wrapped in a material, such as paper, that allows the frame to slip over the body and mat material and then be removed from the assembly.

In various exemplary embodiments, the assembly and methods of the present invention secure the flow-through substrate in the frame such that the bodies substantially remain in place regardless of the angle at which the assembly is positioned. The assembly may be deployed horizontally, vertically, or at a diagonal, for example.

In further exemplary embodiments, the assembly and methods ensure adequate sealing between the flow-through substrate and the frame, regardless of defects or imperfections of the flow-through substrate surface and/or shape, in order to substantially prevent bypass gas flow and maximizing the gas flow through the flow-through substrates.

In additional exemplary embodiments, the assembly and methods of the present disclosure may protect the flow-through substrates from mechanical stimuli by isolating them from potential shock and vibration resulting from installation and operation of the system and/or they may electrically insulate them from the frame and/or insulate them from the reactor housing. In various exemplary embodiments, the compression material, for example mat material, may isolate and/or insulate the flow-through substrate from potential shock and vibration and/or electrical charge.

Unless otherwise indicated, all numbers used in the specification and claims are to be understood as being modified in all instances by the term “about,” whether or not so stated. It should also be understood that the precise numerical values used in the specification and claims form additional embodiments of the invention. Efforts have been made to ensure the accuracy of the numerical values disclosed herein. Any measured numerical value, however, can inherently contain certain errors resulting from the standard deviation found in its respective measuring technique.

As used herein the use of “the,” “a,” or “an” means “at least one,” and should not be limited to “only one” unless explicitly indicated to the contrary. Thus, for example, the use of “the assembly” or “an assembly” is intended to mean at least one assembly.

Other embodiments of the invention will be apparent to those skilled in the art from consideration of the specification and practice of the invention disclosed herein. It is intended that the specification be considered as exemplary only, with a true scope and spirit of the invention being indicated by the claims.

What is claimed is:

1. An assembly comprised of at least two flow-through substrates mounted in a frame,
wherein the at least two flow-through substrates are mounted in the frame with at least one compression material disposed between the flow-through substrates and the frame;
wherein the at least two flow-through substrates are comprised of material configured to capture at least one heavy metal from a fluid stream; and
wherein the assembly is comprised of at least two frame openings.

2. The assembly of claim 1, wherein at least one flow-through substrate comprises activated carbon.

3. The assembly of claim 1, wherein at least one flow-through substrate is a honeycomb body.

4. The assembly of claim 1, wherein the at least one compression material is at least one mat material.

5. An assembly comprised of at least two flow-through substrates bonded together and mounted in a frame,
wherein the at least two flow-through substrates are mounted in the frame with at least one compression material disposed between the flow-through substrates and the frame; and
wherein the at least two flow-through substrates are comprised of material configured to capture at least one heavy metal from a fluid stream.

6. The assembly of claim 5, wherein the at least one compression material comprises at least one mat material.

7. The assembly of claim 5, wherein at least one flow-through substrate comprises activated carbon.

8. The assembly of claim 5, wherein at least one flow-through substrate is a honeycomb body.

9. An assembly comprised of at least two flow-through substrates mounted in a frame, wherein the least two flow-through substrates are bonded to the frame.

10. The assembly of claim 9, wherein at least one flow-through substrate comprises activated carbon.

11. The assembly of claim 9, wherein at least one flow-through substrate is a honeycomb body.

12. The assembly of claim 9, wherein the at least two flow-through substrates are comprised of material configured to capture at least one heavy metal from at least one fluid stream.

13. The assembly of claim 9, wherein at least one compression material is disposed between the flow-through substrates.

14. The assembly of claim 13, wherein the at least one compression material comprises at least one mat material.

15. The assembly of claim 9, wherein the at least two flow-through substrates are bonded together with at least one bonding material.

16. An assembly comprised of at least two flow-through substrates mounted in a frame,
wherein the at least two flow-through substrates are held in place in the frame with at least one retaining member placed at the inlet end and/or outlet end of the flow-through substrates; and
wherein the at least two flow-through substrates are comprised of material configured to capture at least one heavy metal from a fluid stream.

17. The assembly of claim 16, wherein the at least one retaining member is chosen from a mesh or perforated screen, one or more retaining bars, and one or more diagonal bracings or stiffeners.

18. The assembly of claim 16, wherein at least one compression material is disposed between the flow-through substrates and the frame and/or between the at least two flow-through substrates, or, wherein the at least two flow-through substrates are bonded together and/or bonded to the frame.

19. The assembly of claim 16, wherein at least one flow-through substrate comprises activated carbon.

20. The assembly of claim 16, wherein at least one flow-through substrate is a honeycomb body.

21. A method of removing at least one contaminant from a fluid stream, said method comprising passing the fluid stream through an inlet end of the assembly of claim 1.

22. A method of removing at least one contaminant from a fluid stream said method comprising passing the fluid stream through an inlet end of the assembly of claim 5.

23. A method of removing at least one contaminant from a fluid stream said method comprising passing the fluid stream through an inlet end of the assembly of claim 9.

24. A method of removing at least one contaminant from a fluid stream said method comprising passing the fluid stream through an inlet end of the assembly of claim 16.

25. A method for making an assembly comprising at least two frame openings, said method comprising the steps of:
applying at least one first compression material to at least one first flow-through substrate and/or first frame opening;
applying at least one second compression material to at least one second flow-through substrate and/or second frame opening; and
inserting the at least one first and second flow-through substrates into said first and second frame openings respectively;
wherein the at least two flow-through substrates are comprised of material configured to capture at least one heavy metal from at least one fluid stream.

26. The method of claim 25, wherein a pressure created by the at least one first and second compression materials between the at least one first and second flow-through substrates and frame walls independently holds the flow-through substrates in the frame.

27. The method of claim 25, wherein inserting the at least one first and second flow-through substrates into the frame openings comprises pushing the flow-through substrates through a funnel and into the frame openings using a pushing tool.
